(19) United States
(12) Patent Application Publication
(10) Pub. No.: US 2012/0021755 A1
(43) Pub. Date: Jan. 26, 2012

(54) RESOURCE ALLOCATION IN A MULTIPLE USIM MOBILE STATION

(76) Inventors: Tom Chin, San Diego, CA (US); Guangming Shi, San Diego, CA (US); Kuo-Chun Lee, San Diego, CA (US)

(21) Appl. No.: 13/154,279

(22) Filed: Jun. 6, 2011

Related U.S. Application Data
(60) Provisional application No. 61/367,106, filed on Jul. 23, 2010.

(51) Int. Cl. H04W 72/04

(52) U.S. Cl. 455/450

(57) ABSTRACT

Certain aspects of the present disclosure provide techniques for resource allocation for a TD-SCDMA multiple USIM mobile station. According to certain aspects, a base station may send allocation for a first call with a first subscriber identity to a UE that supports multiple subscriber identities, wherein the allocation for the first call comprises allocation of at least a first uplink time slot and at least a first downlink time slot in a frequency carrier and send the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

### CLAIM OF PRIORITY UNDER 35 U.S.C. §119

The present application for patent claims benefit of Provisional Application Ser. No. 61/367,106, filed Jul. 23, 2010, entitled “Resource Allocation in TD-SCDMA Multiple USIM Mobile Station,” and assigned to the assignee hereof and hereby expressly incorporated by reference herein.

### BACKGROUND

1. Field

Certain aspects of the present disclosure relate generally to wireless communication systems, and more particularly, to techniques for resource allocation in TD-SCDMA (Time Division Synchronous Code Division Multiple Access) multiple USIM (Universal Subscriber Identity Module) mobile station.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UTMS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

Certain aspects of the present disclosure provide a method for wireless communications. The method generally includes performing, by a UE that supports multiple subscriber identities, a call setup for a first call with a first subscriber identity, receiving allocation for the first call, wherein the allocation for the first call comprises allocation of at least a first uplink time slot and at least a first downlink time slot in a frequency carrier, during the first call, performing a call setup for a second call with a second subscriber identity and receiving allocation for the second call, wherein the allocation for the second call comprises allocation of at least a second uplink time slot and at least a second downlink time slot in the frequency carrier, wherein the second uplink time slot is different than the first uplink time slot.

Certain aspects of the present disclosure provide an apparatus for wireless communications. The apparatus generally includes means for performing, by a UE that supports multiple subscriber identities, a call setup for a first call with a first subscriber identity, means for receiving allocation for the first call, wherein the allocation for the first call comprises allocation of at least a first uplink time slot and at least a first downlink time slot in a frequency carrier, means for performing a call setup for a second call with a second subscriber identity during the first call and means for receiving allocation for the second call, wherein the allocation for the second call comprises allocation of at least a second uplink time slot and at least a second downlink time slot in the frequency carrier, wherein the second uplink time slot is different than the first uplink time slot.

Certain aspects of the present disclosure provide an apparatus for wireless communications. The apparatus generally includes at least one processor and a memory coupled to the at least one processor. The processor is generally configured to perform, by a UE that supports multiple subscriber identities, a call setup for a first call with a first subscriber identity, receive allocation for the first call, wherein the allocation for the first call comprises allocation of at least a first uplink time slot and at least a first downlink time slot in a frequency carrier, during the first call, perform a call setup for a second call with a second subscriber identity and receive allocation for the second call, wherein the allocation for the second call comprises allocation of at least a second uplink time slot and at least a second downlink time slot in the frequency carrier, wherein the second uplink time slot is different than the first uplink time slot.

Certain aspects of the present disclosure provide a computer-program product for wireless communications, the computer-program product generally includes a computer-readable medium comprising code. The code generally includes code for performing, by a UE that supports multiple subscriber identities, a call setup for a first call with a first subscriber identity, receiving allocation for the first call, wherein the allocation for the first call comprises allocation of at least a first uplink time slot and at least a first downlink time slot in a frequency carrier, during the first call, performing a call setup for a second call with a second subscriber identity and receiving allocation for the second call, wherein the allocation for the second call comprises allocation of at least a second uplink time slot and at least a second downlink time slot in the frequency carrier, wherein the second uplink time slot is different than the first uplink time slot.

Certain aspects of the present disclosure provide a method for wireless communications. The method generally includes sending allocation for a first call with a first subscriber identity to a UE that supports multiple subscriber identities, wherein the allocation for the first call comprises allocation of at least a first uplink time slot and at least a first downlink time slot in a frequency carrier and sending the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

Certain aspects of the present disclosure provide an apparatus for wireless communications. The apparatus generally includes means for sending allocation for a first call with a first subscriber identity to a UE that supports multiple subscriber identities, wherein the allocation for the first call comprises allocation of at least a first uplink time slot and at least a first downlink time slot in a frequency carrier and means for sending the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

Certain aspects of the present disclosure provide an apparatus for wireless communications. The apparatus generally includes at least one processor and a memory coupled to the at least one processor. The processor is generally configured to send allocation for a first call with a first subscriber identity to a UE that supports multiple subscriber identities, wherein the allocation for the first call comprises allocation of at least a first uplink time slot and at least a first downlink time slot in a frequency carrier and send the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

Certain aspects of the present disclosure provide a computer-program product for wireless communications, the computer-program product generally includes a computer-readable medium comprising code. The code generally includes code for sending allocation for a first call with a first subscriber identity to a UE that supports multiple subscriber identities, wherein the allocation for the first call comprises allocation of at least a first uplink time slot and at least a first downlink time slot in a frequency carrier and sending the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a base station in communication with a UE in a telecommunications system.

FIG. 4 is a functional block diagram conceptually illustrating an example TD-SCDMA system using multiple frequency carriers.

FIG. 5 is a functional block diagram conceptually illustrating example components of a base station and a UE capable of performing operations in accordance with aspects of the present disclosure.

FIG. 6 illustrates example operations that may be performed by a UE in accordance with certain aspects of the present disclosure.

FIG. 7 illustrates example operations that may be performed by a base station in accordance with certain aspects of the present disclosure.

FIG. 8 is a functional block diagram conceptually illustrating an example allocation of DL/UL channels for multiple USIMs on a single carrier frequency in accordance with certain aspects of the present disclosure.

FIGS. 9 and 10 are functional block diagrams conceptually illustrating example allocations of time slots for DL/UL channels of multiple USIMs in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

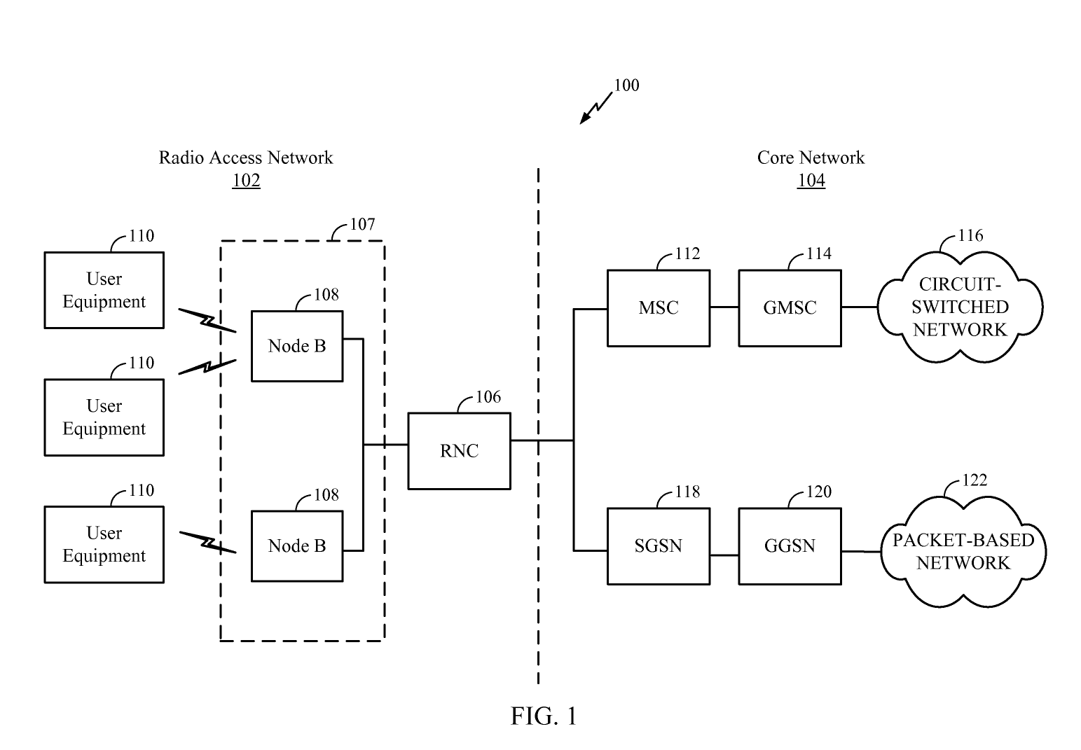

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

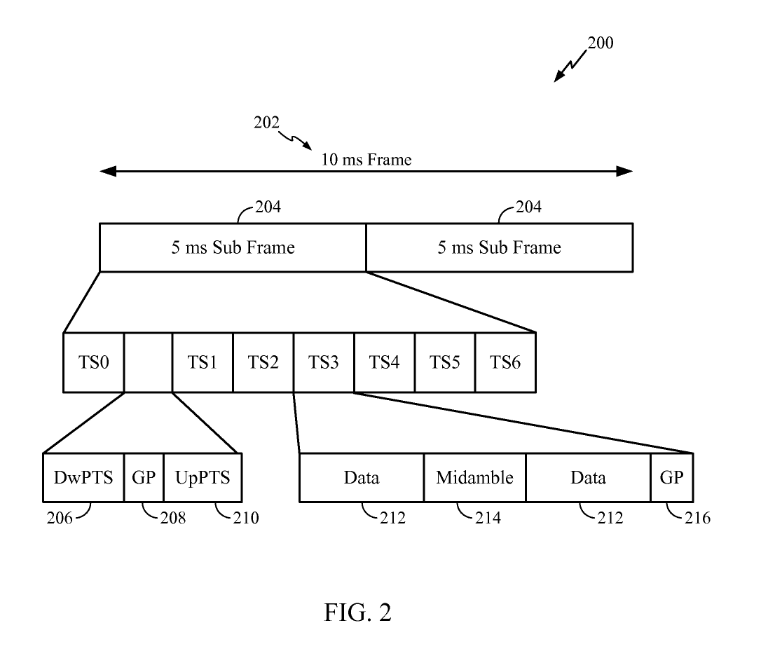

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

According to certain aspects, a UE may be allocated resources in different time slots for calls set up with different mobile identifiers (e.g., IMSIs), as described in greater detail below. In this manner, judicial allocation of time slot and frequency resource may allow the UE to simultaneously engage in the phone calls of the dual USIMs.

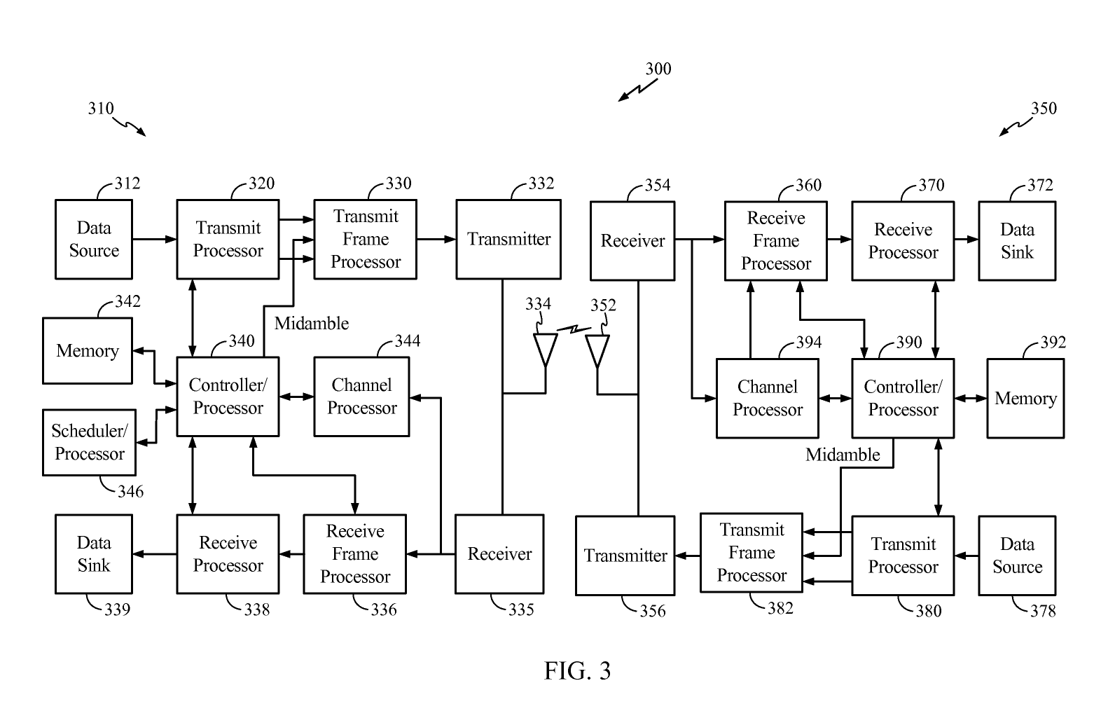

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and de-spreads the symbols, and then determines the most likely signal constellation points transmitted by the Node B 310 based on the modulation scheme. These soft decisions may be based on channel estimates computed by the channel processor 394. The soft decisions are then decoded and de-interleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one embodiment, the components described above with reference to FIG. 3 may be configured to perform operations, as described herein, to allow a user to engage in calls with multiple IMSIs simultaneously.

### Example Resource Allocation in a Multiple USIM Mobile Station

TD-SCDMA (Time Division Synchronous Code Division Multiple Access) is based on time division and code division in order to allow multiple UEs (User Equipments) to share a same radio bandwidth on a particular frequency channel. The bandwidth of each frequency channel in the TD-SCDMA system is 1.6 MHz, operating at 1.28 Mega chips per second. The downlink and uplink transmissions share the same bandwidth in different time slots (TSs). In each time slot, there are multiple code channels. As discussed in the above paragraphs, in a typical TD-SCDMA frame, one downlink (DL) TS0 is followed by three uplink (UL) TS1˜TS3, and followed by three DL TS4˜TS6. Between TS0 and TS1, there are Downlink Pilot Time Slot (DwPTS) and Uplink Pilot Time Slot (UpPTS), separated by the gap. DwPTS is used to transmit DwPCH (Downlink Pilot Channel).

In order to provide more capacity, the TD-SCDMA system may support multiple carriers.

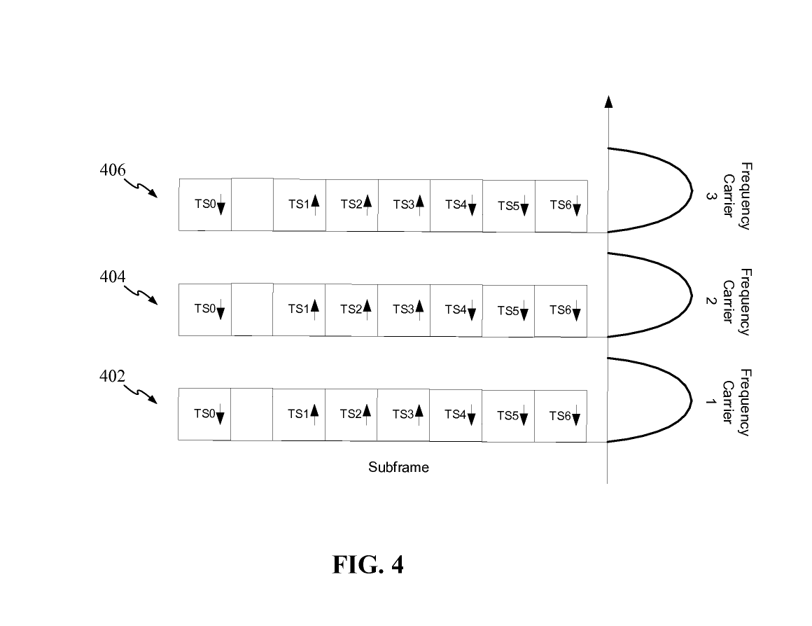

For example, FIG. 4 is a functional block diagram conceptually illustrating an example TD-SCDMA system 400 using multiple frequency carriers. The system 400 shows three separate frequency carriers 1, 2 and 3 used for transmission of each of the TD-SCDMA subframes 402, 404 and 406 respectively. Thus, a cell may have multiple carriers whereby the data may be transmitted on each of the multiple frequency carriers to increase capacity.

Mobile phones with multiple USIMs (Universal Subscriber Identity Modules) are fairly popular. For example a mobile phone may have dual USIMs enabling a user to make/receive phone calls in different numbers. Typically each USIM has a unique IMSI (International Mobile Subscriber Identity).

The dual USIM phones may be standby dual-USIM phones or active dual-USIM phones. Standby dual-SIM phones allow the phone to switch from one USIM to the other as required but do not allow both USIMs to be active at the same time. Active dual-USIM phones allow both USIMs to be active at the same time.

However, a dual USIM mobile terminal may only have one TD-SCDMA hardware module which may need to support multiple traffic channels set up for the dual USIMs. In some cases, the mobile terminal may only be capable of transmitting and receiving on a single frequency carrier. If the dual USIMs have phone calls allocated on different frequency carriers, then the narrowband TD-SCDMA module may not allow a user to engage in multiple phone calls simultaneously.

Certain aspects of the present disclosure, however, provide a technique that may allow multiple phone calls to be simultaneously supported in dual-USIM TD-SCDMA mobile terminals. According to certain aspects, such a technique may involve judicial allocation of time slot and frequency resources, allowing a mobile terminal (e.g., a U.E.) to simultaneously engage in multiple phone calls (e.g., one for each of dual USIMs).

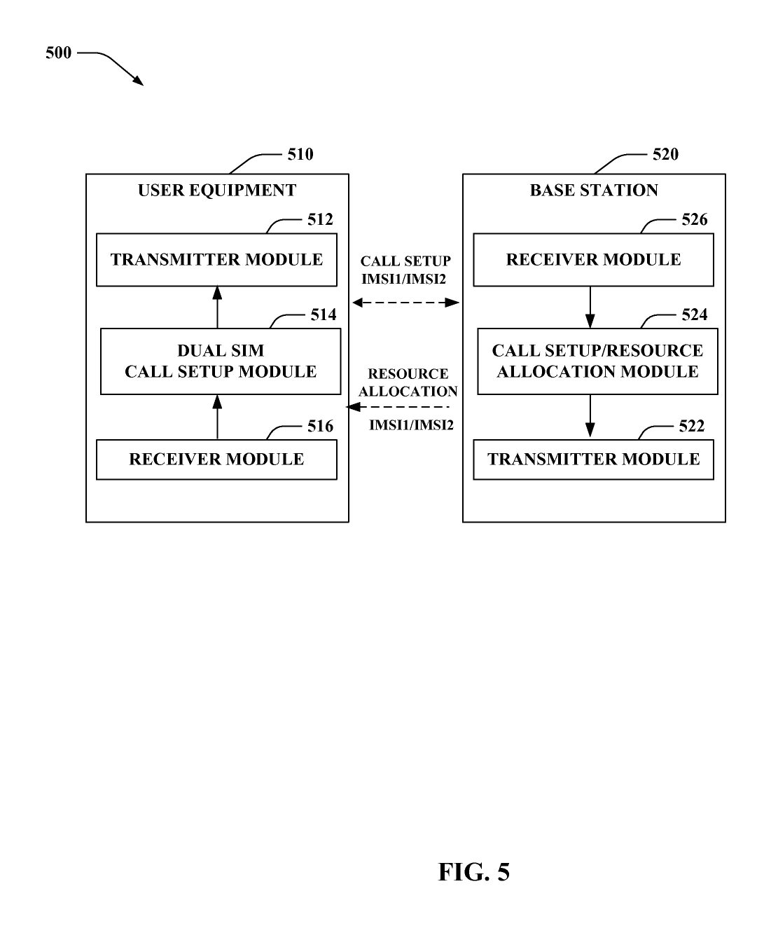

FIG. 5 illustrates an example UE 510 that may support multiple SIs (USIMs or IMSIs) capable of supporting multiple phone calls (for the multiple SIs) simultaneously. As illustrated, the UE 510 may include a Dual SIM Call Setup module 514. The Dual SIM Call Setup module 514 may be configured to perform call setup procedures for multiple SIs. Each call setup procedure may involve the exchange of messages with base station 520, for example, utilizing transmitter module 512 and receiver module 516 of the UE 510 and transmitter module 522 and receiver module 526 of the UE 520.

As illustrated, the BS 520 may include a Dual SIM Call Setup/Resource allocation module 524. As will be described in greater detail below, the Dual SIM Call Setup/Resource allocation module 524 may be configured to allocate resources for a first call with a first subscriber identity to the UE 510, wherein the allocation for the first call comprises allocation of at least a first uplink time slot and at least a first downlink time slot in a frequency carrier. The Dual SIM Call Setup/Resource allocation module 524 may also allocate resources for a second call with a second subscriber identity, wherein the allocation for the second call comprises allocation of at least a second uplink time slot and at least a second downlink time slot in the frequency carrier, wherein the second uplink time slot is different than the first uplink time slot.

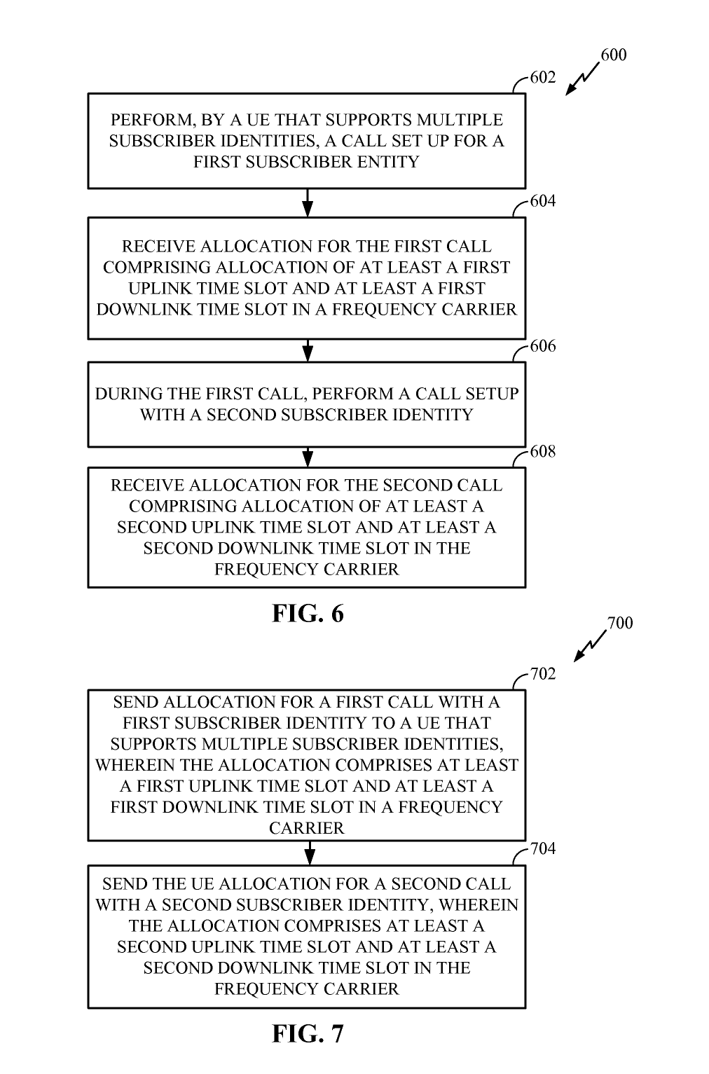

FIG. 6 illustrates example operations 600 that may be performed by a user terminal in accordance with certain aspects of the present disclosure.

The operations 600 begin, at 602, by performing a call setup for a first call with a first subscriber identity. At 604, allocation for the first call is received, wherein the allocation for the first call comprises allocation of at least a first uplink time slot and at least a first downlink time slot in a frequency carrier. At 606, during the first call, performing a call setup for second call with a second subscribe identity. At 608, receiving allocation for the second call, wherein the allocation for the second call comprises allocation of at least a second uplink time slot and at least a second downlink time slot in the frequency carrier, wherein the second uplink time slot is different than the first uplink time slot.

FIG. 7 illustrates example operations 700 that may be performed by an NB (NodeB) in accordance with certain aspects of the present disclosure.

The operations 700 begin, at 702, by sending allocation for the first call, wherein the allocation for the first call comprises allocation of at least a first uplink time slot and at least a first downlink time slot in a frequency carrier. At 704, the UE is sent an allocation for a second call with a second subscriber identity, wherein the allocation for the second call comprises allocation of at least a second uplink time slot and at least a second downlink time slot in the frequency carrier, wherein the second uplink time slot is different than the first uplink time slot.

### Multiple USIM Operation Using Single Frequency Carrier

According to certain aspects, resources allocated for the phone calls of multiple USIMs (e.g. the two phone calls of the dual USIMs) may involve DL/UL DPCH (Dedicated Physical Channel) on the same frequency instead of different frequencies.

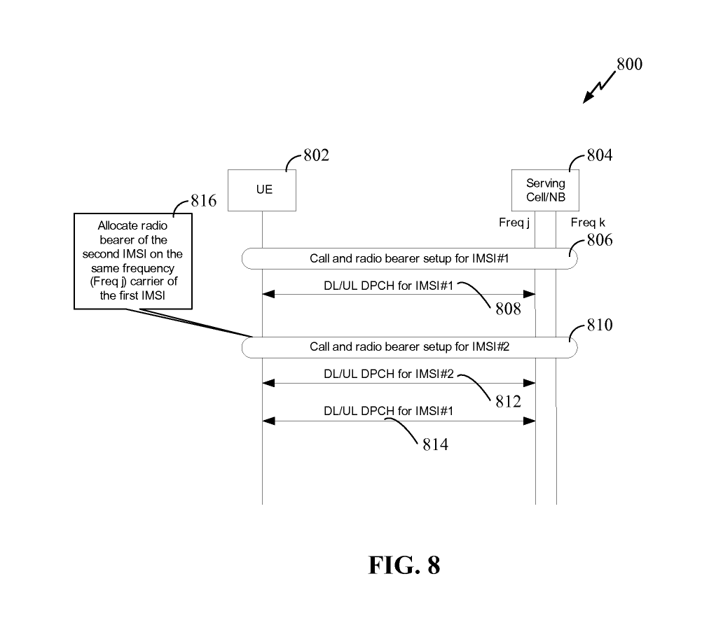

For example, FIG. 8 is a functional block diagram conceptually illustrating an example allocation 800 of DL/UL channels for multiple USIMs on a single carrier frequency in accordance with certain aspects of the present disclosure. As noted at 816, the allocation of DL/UL DPCH channels for IMSI#1 and IMSI#2 on the same frequency channel (e.g. Freq j), for transmission between UE 802 and Serving Cell/NB 804. IMSI#1 and IMSI#2 may uniquely identify corresponding USIMs in the UE 802.

At 806, a call is set up, typically by the UE for IMSI#1. The call setup may include allocating DL/UL DPCHs for IMSI#1, typically by NB 804, on a frequency carrier (e.g. Freq j). Transmission for IMSI#1 between NB 804 and UE 802 may start using the allocated frequency carrier at 808.

At 810, another call is set up, typically the UE 802, for IMSI#2. The call setup may include allocating DL/UL DPCHs for IMSI#2, also typically by NB 804, on the same frequency carrier as IMSI#1 (e.g. Freq j). Simultaneous transmissions of calls for both IMSI#1 and IMSI#2 may take place using the same frequency carrier between the UE 802 and NB 804 at 812 and 814.

According to certain aspects, the UE 802 may have limited uplink transmission power and, therefore, the UL DPCHs may be allocated on different UL TSs (Time Slots). Alternatively, the UE 802 may transmit at a higher power on the same UL TS. However, according to certain aspects, this may result in a maximum power of the UEs power amplifier being exceeded.

According to certain aspects, the UE may need to receive from different downlink time slots in order to smoothen the processing load. Thus, in certain aspects, it is proposed to allocate the DPCHs for the phone calls of the multiple USIMs in different DL and UL TSs.

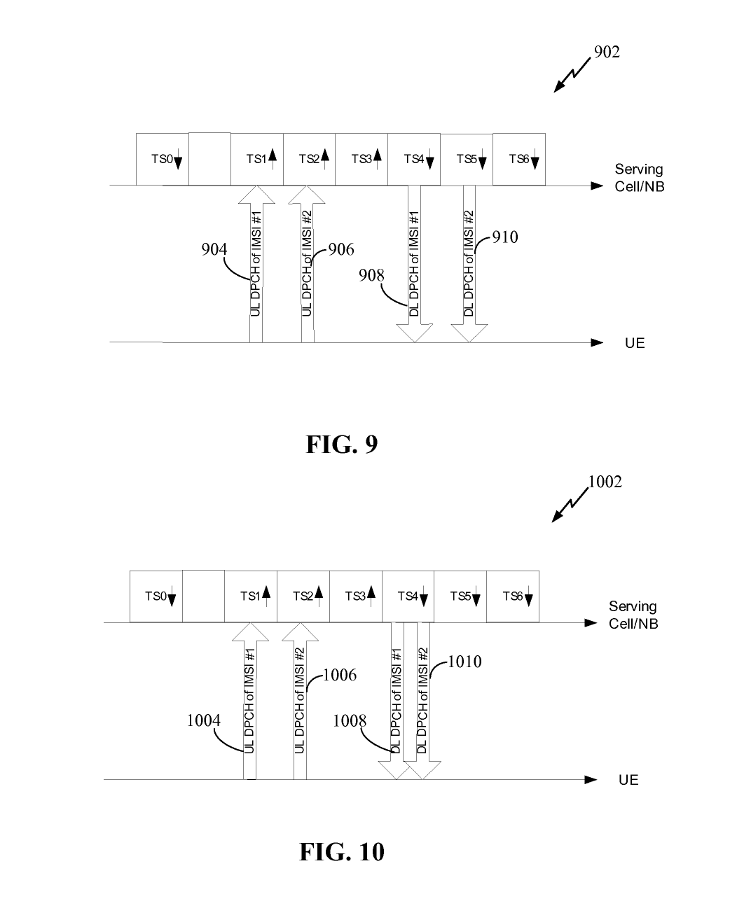

FIG. 9 is a functional block diagram conceptually illustrating an example allocation of time slots for DL/UL channels of multiple USIMs in accordance with certain aspects of the present disclosure. As illustrated, TD-SCDMA subframe 902 includes four DL TSs, TS0, TS4, TS5 and TS6, and three UL TSs, TS1, TS2 and TS3. Each UL DPCH (904, 906) and DL DPCH (908, 910) of IMSI#1 and IMSI#2 may be allocated in separate UL and DL TSs, respectively. For example, UL DPCH 904 of IMSI#1 may be allocated in UL TS1 and UL DPCH 906 IMSI#2 may be allocated in UL TS TS2. Similarly, DL DPCH 908 of IMSI#1 may be allocated in DL TS TS4 and DL DPCH 910 of IMSI#2 may be allocated in DL TS5.

In certain aspects, if the CPU processing load is not an issue for the UE, the DL DPCHs for the dual USIMs may be allocated in the same DL TS, as illustrated in FIG. 10. However, according to certain aspects, the power limitation of the UE may still require allocating the UL DPCHs in different UL TSs.

FIG. 10 illustrates an example allocation of time slots for DL/UL channels of multiple USIMs in accordance with certain aspects of the present disclosure. As illustrated, TD-SCDMA subframe 1002 includes four DL TSs (TS0, TS4, TS5 and TS6) and three UL TSs (TS1, TS2 and TS3). UL DPCH 1004 of IMSI#1 may be allocated in UL TS1 and UL DPCH 1006 of IMSI#2 may be allocated in UL TS2. As illustrated, DL DPCHs 1008 and 1010 for both IMSI#1 and IMSI#2 may be allocated to the same DL TS4.

Thus, according to certain aspects, the proposed techniques may provide TS/frequency resource allocation to accommodate the device constraints of transmit power and CPU processing in supporting the multiple USIM configuration.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communications, comprising:
performing, by a UE that supports multiple subscriber identities, a call setup for a first call with a first subscriber identity;
receiving allocation for the first call, wherein the allocation for the first call comprises allocation of at least a first uplink time slot and at least a first downlink time slot in a frequency carrier;
during the first call, performing a call setup for a second call with a second subscriber identity; and
receiving allocation for the second call, wherein the allocation for the second call comprises allocation of at least a second uplink time slot and at least a second downlink time slot in the frequency carrier, wherein the second uplink time slot is different than the first uplink time slot.

2. The method of claim 1, wherein the second downlink time slot is different than the first downlink time slot.

3. The method of claim 1, wherein:
receiving allocation for the first call comprises receiving allocation for a first one or more dedicated physical channels (DPCHs); and
receiving allocation for the second call comprises receiving allocation for a second one or more DPCH.

4. The method of claim 3, wherein the first one or more DPCHs comprise at least one uplink DPCH and at least one downlink DPCH.

5. The method of claim 4, wherein at least one downlink DPCH for the first call and at least one downlink DPCH for the second call are both allocated on the same downlink time slot.

6. The method of claim 1, wherein:
at least one uplink DPCH for the first call is allocated on the first uplink time slot; and
at least one uplink DPCH for the second call is allocated on the second uplink time slot.

7. An apparatus for wireless communications, comprising:
means for performing, by a UE that supports multiple subscriber identities, a call setup for a first call with a first subscriber identity;
means for receiving allocation for the first call, wherein the allocation for the first call comprises allocation of at least a first uplink time slot and at least a first downlink time slot in a frequency carrier;
means for performing a call setup for a second call with a second subscriber identity during the first call; and
means for receiving allocation for the second call, wherein the allocation for the second call comprises allocation of at least a second uplink time slot and at least a second downlink time slot in the frequency carrier, wherein the second uplink time slot is different than the first uplink time slot.

8. The apparatus of claim 7, wherein the second downlink time slot is different than the first downlink time slot.

9. The apparatus of claim 7, wherein:
means for receiving allocation for the first call comprises means for receiving allocation for a first one or more dedicated physical channels (DPCHs); and
means for receiving allocation for the second call comprises means for receiving allocation for a second one or more DPCH.

10. The apparatus of claim 9, wherein the first one or more DPCHs comprise at least one uplink DPCH and at least one downlink DPCH.

11. The apparatus of claim 10, wherein at least one downlink DPCH for the first call and at least one downlink DPCH for the second call are both allocated on the same downlink time slot.

12. The apparatus of claim 7, wherein:
at least one uplink DPCH for the first call is allocated on the first uplink time slot; and
at least one uplink DPCH for the second call is allocated on the second uplink time slot.

13. An apparatus for wireless communications, comprising:
at least one processor configured to:
perform, by a UE that supports multiple subscriber identities, a call setup for a first call with a first subscriber identity;
receive allocation for the first call, wherein the allocation for the first call comprises allocation of at least a first uplink time slot and at least a first downlink time slot in a frequency carrier;
during the first call, perform a call setup for a second call with a second subscriber identity; and
receive allocation for the second call, wherein the allocation for the second call comprises allocation of at least a second uplink time slot and at least a second downlink time slot in the frequency carrier, wherein the second uplink time slot is different than the first uplink time slot; and
a memory coupled to the at least one processor.

14. The apparatus of claim 13, wherein the second downlink time slot is different than the first downlink time slot.

15. The apparatus of claim 13, wherein the processor is configured to:
receive allocation for the first call by receiving allocation for a first one or more dedicated physical channels (DPCHs); and
receive allocation for the second call by receiving allocation for a second one or more DPCH.

16. The apparatus of claim 15, wherein the first one or more DPCHs comprise at least one uplink DPCH and at least one downlink DPCH.

17. The apparatus of claim 16, wherein at least one downlink DPCH for the first call and at least one downlink DPCH for the second call are both allocated on the same downlink time slot.

18. The apparatus of claim 13, wherein:
at least one uplink DPCH for the first call is allocated on the first uplink time slot; and
at least one uplink DPCH for the second call is allocated on the second uplink time slot.

19. A computer-program product for wireless communications, the computer-program product comprising:
a computer-readable medium comprising code for:
performing, by a UE that supports multiple subscriber identities, a call setup for a first call with a first subscriber identity;
receiving allocation for the first call, wherein the allocation for the first call comprises allocation of at least a first uplink time slot and at least a first downlink time slot in a frequency carrier;
during the first call, performing a call setup for a second call with a second subscriber identity; and
receiving allocation for the second call, wherein the allocation for the second call comprises allocation of at least a second uplink time slot and at least a second downlink time slot in the frequency carrier, wherein the second uplink time slot is different than the first uplink time slot.

20. The computer-program product of claim 19, wherein the second downlink time slot is different than the first downlink time slot.

21. The computer-program product of claim 19, wherein:
receiving allocation for the first call comprises receiving allocation for a first one or more dedicated physical channels (DPCHs); and
receiving allocation for the second call comprises receiving allocation for a second one or more DPCH.

22. The computer-program product of claim 21, wherein the first one or more DPCHs comprise at least one uplink DPCH and at least one downlink DPCH.

23. The computer-program product of claim 22, wherein at least one downlink DPCH for the first call and at least one downlink DPCH for the second call are both allocated on the same downlink time slot.

24. The computer-program product of claim 19, wherein:
at least one uplink DPCH for the first call is allocated on the first uplink time slot; and
at least one uplink DPCH for the second call is allocated on the second uplink time slot.

25. A method for wireless communications, comprising:
sending allocation for a first call with a first subscriber identity to a UE that supports multiple subscriber identities, wherein the allocation for the first call comprises allocation of at least a first uplink time slot and at least a first downlink time slot in a frequency carrier; and
sending the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

26. The method of claim 25, wherein the second downlink time slot is different than the first downlink time slot.

27. The method of claim 25, wherein:
sending allocation for the first call comprises sending allocation for a first one or more dedicated physical channels (DPCHs); and
sending allocation for the second call comprises sending allocation for a second one or more DPCH.

28. The method of claim 27, wherein the first one or more DPCHs comprise at least one uplink DPCH and at least one downlink DPCH.

29. The method of claim 28, wherein at least one downlink DPCH for the first call and at least one downlink DPCH for the second call are both allocated on the same downlink time slot.

30. The method of claim 25, wherein:
at least one uplink DPCH for the first call is allocated on the first uplink time slot; and
at least one uplink DPCH for the second call is allocated on the second uplink time slot.

31. An apparatus for wireless communications, comprising:
means for sending allocation for a first call with a first subscriber identity to a UE that supports multiple subscriber identities, wherein the allocation for the first call comprises allocation of at least a first uplink time slot and at least a first downlink time slot in a frequency carrier; and
means for sending the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

32. The apparatus of claim 31, wherein the second downlink time slot is different than the first downlink time slot.

33. The apparatus of claim 31, wherein:
means for sending allocation for the first call comprises means for sending allocation for a first one or more dedicated physical channels (DPCHs); and
means for sending allocation for the second call comprises means for sending allocation for a second one or more DPCH.

34. The apparatus of claim 33, wherein the first one or more DPCHs comprise at least one uplink DPCH and at least one downlink DPCH.

35. The apparatus of claim 34, wherein at least one downlink DPCH for the first call and at least one downlink DPCH for the second call are both allocated on the same downlink time slot.

36. The apparatus of claim 31, wherein:
at least one uplink DPCH for the first call is allocated on the first uplink time slot; and
at least one uplink DPCH for the second call is allocated on the second uplink time slot.

37. An apparatus for wireless communications, comprising:
at least one processor configured to:
send allocation for a first call with a first subscriber identity to a UE that supports multiple subscriber identities, wherein the allocation for the first call comprises allocation of at least a first uplink time slot and at least a first downlink time slot in a frequency carrier; and
send the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot; and
a memory coupled to the at least one processor.

38. The apparatus of claim 37, wherein the second downlink time slot is different than the first downlink time slot.

39. The apparatus of claim 37, wherein the processor is configured to:
send allocation for the first call by sending allocation for a first one or more dedicated physical channels (DPCHs); and
send allocation for the second call by sending allocation for a second one or more DPCH.

40. The apparatus of claim 39, wherein the first one or more DPCHs comprise at least one uplink DPCH and at least one downlink DPCH.

41. The apparatus of claim 40, wherein at least one downlink DPCH for the first call and at least one downlink DPCH for the second call are both allocated on the same downlink time slot.

42. The apparatus of claim 37, wherein:
at least one uplink DPCH for the first call is allocated on the first uplink time slot; and
at least one uplink DPCH for the second call is allocated on the second uplink time slot.

43. A computer-program product for wireless communications, the computer-program product comprising:
a computer-readable medium comprising code for:
sending allocation for a first call with a first subscriber identity to a UE that supports multiple subscriber identities, wherein the allocation for the first call comprises allocation of at least a first uplink time slot and at least a first downlink time slot in a frequency carrier; and
sending the UE allocation for a second call with a second subscriber identity, wherein the allocation for the second call comprises allocation of at least a second uplink time slot and at least a second downlink time slot in the frequency carrier, wherein the second uplink time slot is different than the first uplink time slot.

44. The computer-program product of claim 43, wherein the second downlink time slot is different than the first downlink time slot.

45. The computer-program product of claim 43, wherein:
sending allocation for the first call comprises sending allocation for a first one or more dedicated physical channels (DPCHs); and
sending allocation for the second call comprises sending allocation for a second one or more DPCH.

46. The computer-program product of claim 45, wherein the first one or more DPCHs comprise at least one uplink DPCH and at least one downlink DPCH.

47. The computer-program product of claim 46, wherein at least one downlink DPCH for the first call and at least one downlink DPCH for the second call are both allocated on the same downlink time slot.

48. The computer-program product of claim 43, wherein:
at least one uplink DPCH for the first call is allocated on the first uplink time slot; and
at least one uplink DPCH for the second call is allocated on the second uplink time slot.
